(19) United States
(12) Patent Application Publication
(10) Pub. No.: US 2008/0300986 A1
(43) Pub. Date: Dec. 4, 2008

(54) METHOD AND SYSTEM FOR CONTEXTUAL ADVERTISEMENT

(75) Inventor: Woosung Lee, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: NHN CORPORATION, Seongnam-si (KR)

(21) Appl. No.: 12/130,653

(22) Filed: May 30, 2008

(30) Foreign Application Priority Data
Jun. 1, 2007 (KR) 10-2007-0053720

(51) Int. Cl. G06Q 30/00

(52) U.S. Cl. 705/14

(57) ABSTRACT

A method and system for providing an advertisement, and a method and system for providing training data with respect to providing of an advertisement are provided. The advertisement providing method includes: verifying a document displayed on a web page; providing a user with a recommendation advertisement list associated with the document; verifying an advertisement that is selected by the user from the recommendation advertisement list; and providing the advertisement via the web page. The method may further include: selecting, from the recommendation advertisement list, a system advertisement that is different from a selected advertisement, wherein the selected advertisement is the advertisement selected by the user. The providing of the advertisement may include providing the first advertisement and the system advertisement via the web page.

### CROSS-REFERENCE TO RELATED APPLICATIONS

This application claims the benefit of Korean Patent Application No. 10-2007-0053720, filed on Jun. 1, 2007, in the Korean Intellectual Property Office, the disclosure of which is incorporated herein by reference.

### BACKGROUND OF THE DISCLOSURE

1. Field

The present disclosure relates to advertising on a web page, and more particularly, to contextual advertising on a web page.

2. Description of the Related Art

Contextual advertising is advertising that adjusts its contents based on visitation habits of visitors of a website and contents of a web page that the visitors are currently viewing. Contextual advertising may appear as an advertisement in a pop-up window on a search web page and may be related to search words used by the visitors in the web site. As another example, contextual advertising may adjust according to the behavior of other users that visit the same page or document included in the web page.

Contextual advertising typically attempts to provide advertisements that are relevant to the content of the document displayed. But, it is difficult to reliably determine which advertisements are relevant to a document displayed on a web page. In addition, it can be difficult to select advertisements that have a reliable advertising effect.

The foregoing discussion is to provide general background information, and does not constitute an admission of prior art.

### SUMMARY

One of the embodiments provides a method of advertising comprising: analyzing a document to be posted on a web page so as to generate a list of advertisements to be displayed or played along with the document on the web page; providing the generated list of advertisements to a posting user posting the document on the web page; receiving a selection of the posting user from the generated list; associating the selection with the document and the web page; and transmitting advertisement content of the selection to a terminal associated with a viewing user of the web page such that the advertisement content is displayed or played along with the document on the terminal.

Another embodiment provides a method of posting a document on a web page with at least one advertisement comprising: submitting, by a posting user, a document for posting on a web page; receiving, by the posting user, a request for selecting at least on of a list of advertisements for displaying or playing along with the document on the web page; sending, by the posting user, a selection of the posting user from the list; viewing, by the posting user, the document on the web page; and viewing or listening to, by the posting user, the selected advertisement content of the selection displayed or played along with the document on the web page.

Yet another embodiment provides a method of advertisement at a terminal associated with a user viewing a document on a web page comprising: receiving a document to be displayed on a web page; receiving advertisement content to be displayed or played along with the document on the web page for at least one of an advertisement selected by a posting user that is to be posted with the document on the web page and at least one non-selected advertisement based on advertising effectiveness of the advertisement selected by the posting user and the advertising effectiveness of the at least one non-selected advertisement; providing the web page on the terminal; and providing advertisement content for the advertisement to be displayed or played along with the document on the web page.

One aspect of the present disclosure provides a method of providing an advertisement, including: verifying a document displayed on a web page; providing a user with a recommendation advertisement list associated with the document; verifying an advertisement that is selected by the user from the recommendation advertisement list; and providing the advertisement via the web page. The recommendation advertisement list may include a list of a predetermined number of advertisements that are extracted based on a correlation or relevance with the document. The advertisement may include contextual advertising.

In the forgoing method, the method may further include: selecting, from the recommendation advertisement list, a second advertisement that is different from a first advertisement, wherein the first advertisement is the advertisement selected by the user. The providing of the advertisement may include providing the first advertisement and the second advertisement via the web page.

The verifying of the document may include verifying the document when the document is registered on the web page, or verifying the document when an advertisement verification field is added and maintained on the web page and an event occurs in the advertisement verification field.

The providing of the recommendation advertisement list may include: extracting a predetermined number of advertisements based on a correlation or relevance with the document; generating a list of the predetermined number of extracted advertisements as the recommendation advertisement list; and providing the user with the recommendation advertisement list via the web page or another web page.

Another aspect of the present disclosure provides a method of collecting training data with respect to providing of an advertisement, includes: verifying an advertisement selected by a user in association with a document; providing the advertisement via a web page associated with the document to thereby measure advertising effect of the advertisement; and storing the advertisement in association with the advertising effect and the document. The method may further include selecting a second advertisement that is different from a first advertisement based on a correlation or relevance with the document, wherein the first advertisement is the advertisement selected by the user. In this case, the providing and the measuring may include providing the first advertisement and the second advertisement via the web page to thereby measure advertising effect of the first advertisement and advertising effect of the second advertisement.

An aspect of the present disclosure provides a method and system for providing an advertisement that can provide an advertisement that is selected by a user from a recommendation advertisement list in association with a document displayed on a web page, via the web page and thereby can provide an advertisement that has a greater correlation or relevance with the document.

Another aspect of the present disclosure also provides a method and system for providing an advertisement that can display a first advertisement selected by a user and a second advertisement selected by an advertisement system, based on the same ratio of traffic, measure advertising effect, for example, a click through rate (CTR), of the first advertisement and the second advertisement, and distribute returns to the user based on the measured advertising effect and thereby can motivate the user to improve the service quality and the advertising effect.

Another aspect of the present disclosure also provides a method and system for collecting training data that can store an advertisement with greater advertising effect between a first advertisement and a second advertisement in association with a document and use data associated with the stored advertisement and the document as training data for improving an engine of an advertisement system and thereby can improve the accuracy of the advertisement system.

### BRIEF DESCRIPTION OF THE DRAWINGS

The above and/or other aspects and advantages of the present disclosure will become apparent and more readily appreciated from the following detailed description, taken in conjunction with the accompanying drawings of which:

FIG. 1 illustrates a system for providing an advertisement according to an embodiment of the present disclosure;

FIG. 2 is a flowchart illustrating a method of providing an advertisement according to an embodiment of the present disclosure;

FIG. 3 is a flowchart illustrating a method of providing a recommendation advertisement list according to an embodiment of the present disclosure;

FIG. 4 illustrates an example of providing an advertisement according to an embodiment of the present disclosure;

FIG. 5 is a block diagram illustrating an internal configuration of an advertisement system according to an embodiment of the present disclosure;

FIG. 6 is a flowchart illustrating a method of collecting training data according to an embodiment of the present disclosure;

FIG. 7 is a flowchart illustrating a method of verifying an advertisement selected by a user and an advertisement selected by a training data collecting system according to an embodiment of the present disclosure; and

FIG. 8 is a block diagram illustrating an internal configuration of a training data collecting system according to an embodiment of the present disclosure.

### DETAILED DESCRIPTION OF EMBODIMENTS

Reference will now be made in detail to exemplary embodiments of the present disclosure, examples of which are illustrated in the accompanying drawings, wherein like reference numerals refer to the like elements throughout. The exemplary embodiments are described below in order to explain the present disclosure by referring to the figures.

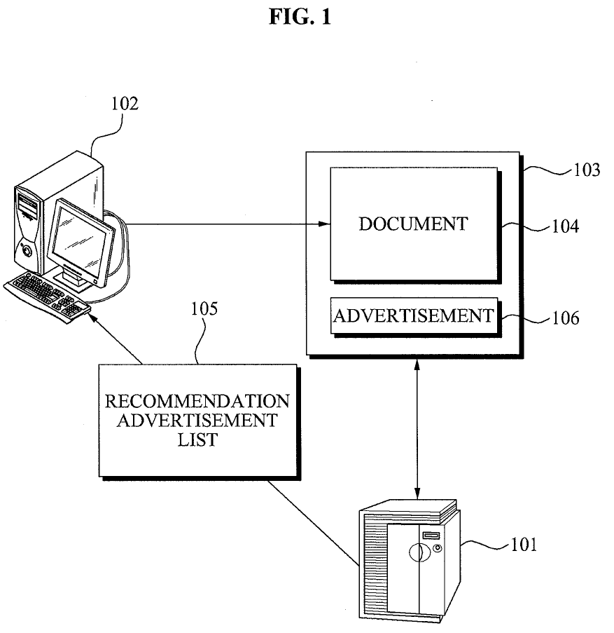

FIG. 1 illustrates an advertisement system 101 for providing advertisements according to an embodiment of the present disclosure. As shown, the advertisement system 101 may be coupled to a terminal 102, which may display a web page 103 used by a posting user of a document 104. The web page 103 may be intended to comprise the document 104 and an advertisement 106 when it is displayed to viewing users. The advertisement system 101 may recommend advertisements in recommendation advertisement list 105 for advertisement 106 that may be effective when displayed with document 104 on web page 103.

As shown, the advertisement system 101 may be implemented using a server or other type of computing device. Such hardware and software are well known to those skilled in the art.

The terminal 102 can provide an interface for a posting user to post document 104 on web page 103. In addition, the terminal 102 may provide an interface in which the posting user provides input as to which advertisements are displayed or played with the document 104 on web page 103. The terminal 102 may be implemented using well known hardware and software, such as a personal computer, server, mobile phone, etc.

The web page 103 may be viewed or played on terminal 102, another computer (not shown) or other device, such as a mobile phone, that is capable of displaying web pages and playing content. The web page 103 may be implemented using well known program code, such as hypertext markup language, JavaScript, Ajax, stylesheets, etc., for static and dynamic content.

The document 104 may represent any content that is static or dynamic that the posting user wishes to be displayed on the web page 103. For example, the document 104 may be a text file, image file, multimedia file, etc.

The recommendation advertisement list 105 includes information indicating one or more advertisements that may be considered effective by the advertisement service 101. The recommendation advertisement list 105 may include information about advertisements, such as their title, location, file type, compensation or revenue information, and the like.

The advertisement 106 generally refers to any advertisement placement on a web page or website. The advertisement 106 may be displayed or played in various forms, such as text, a banner advertisement, an image, a multimedia object that is played on the web page 103, a pop-up, etc. Any form of advertisement is intended to be within the embodiments of the present disclosure.

When a posting user places the document 104 on a web page 103 via the terminal 102, the advertisement system 101 may provide the user with a recommendation advertisement list 105. The advertisement system 101 may provide the recommendation advertisement list 105 automatically or in response to a request from the terminal 102. The recommendation advertisement list 105 may be provided to the posting user at terminal 102 in the form of a web page, a pop-up menu, and the like.

The advertisement system 101 may also provide the advertisements or a portion of the advertisements included in the recommendation advertisement list 105 via the web page 103 in association with the document 104. The posting user may edit the placement of the document 104 on the web page 103. For example, the posting user may be attempting to select and configure advertisements that will appear on web pages like a blog, a cafe, and the like.

The advertisement system 101 may optionally verify any advertisement that is selected by the posting user (herein referred to as the selected advertisement) is from the recommendation advertisement list 105 and display the selected advertisement on the web page 103. In addition to the advertisement that was selected by the posting user, the advertisement system 101 may select another, different advertisement from the advertisement recommendation list 105 (herein referred to as the system advertisement or a non-selected advertisement). In order to select this system advertisement, the advertisement system 101 may employ existing contextual advertising schemes and algorithms. For example, the advertisement system 101 may measure a correlation or relevance between the document 104 and select the system advertisement, based on vocabulary included in the document 104.

Initially, the advertisement system 101 may provide the selected advertisement and the system advertisement substantially equally for display or playback as the advertisement 106 when the web page 103 is requested by various viewing users. The advertisement system 101 may then measure advertising effect, such as a click-through rate, display time, etc., of these advertisements when they appear as the advertisement 106 displayed on the web page 103 to viewing users. This analysis may be useful, for example, to improve reliability and accuracy of the contextual advertising provided from the advertisement system 101. In addition, this analysis and comparison of the relative effects of the selected advertisement and the system advertisement may be used as information to train the advertisement system 101 in deciding which advertisement to recommend in the recommendation list 105. These and other advantages and features will be apparent to those skilled in the art.

In addition, the advertisement system 101 may measure advertising effects of both the advertisements and provide the posting user with a predetermined compensation amount based on the measured advertising effect. Furthermore, the advertisement system 101 may store in a database (not shown) the advertisement with the greater advertising effect for continued use with the document 104.

Of course, the advertisement system 101 may provide various combinations of advertisements for placement as advertisement 106 on the web page 103. For example, the advertisement system 101 may provide both the selected advertisement and system advertisement for display or playback on the web page 103 with the document 104.

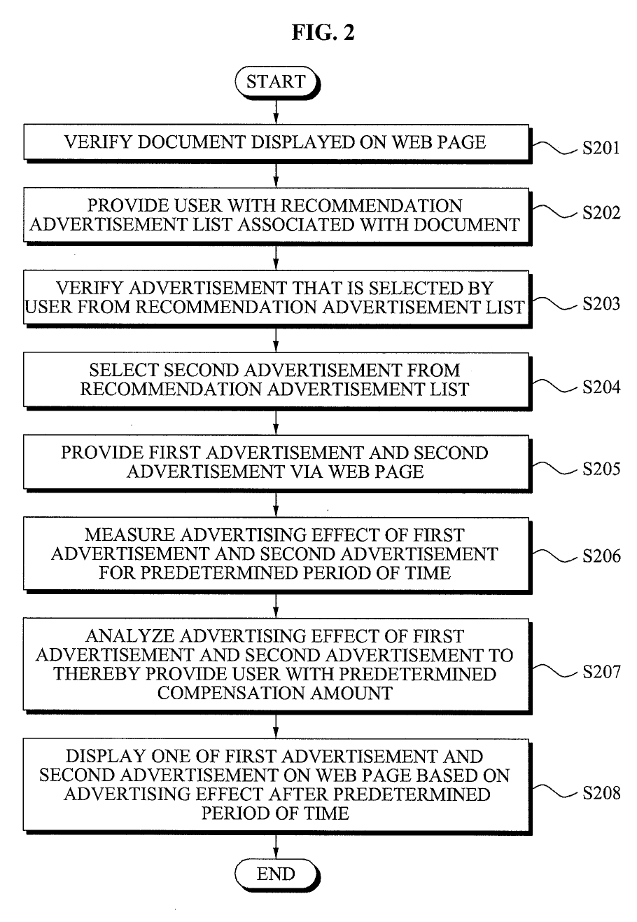

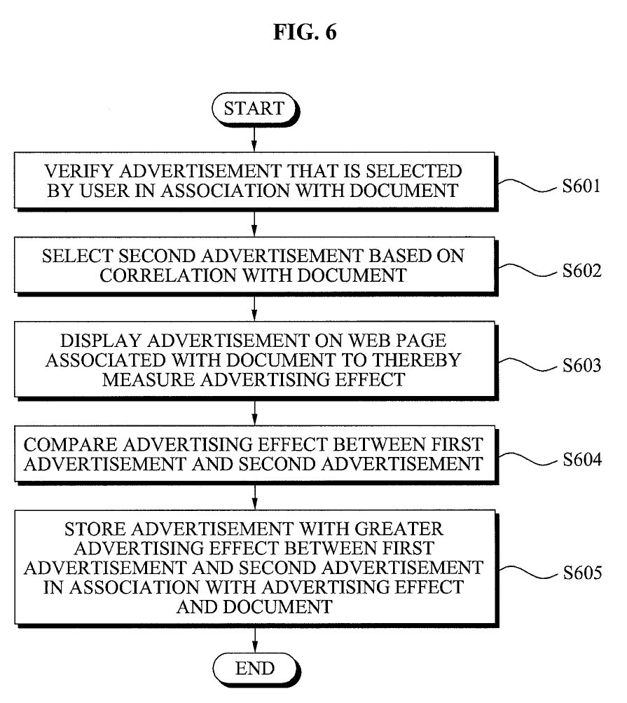

FIGS. 2 through 5 may illustrate various aspects of selecting and providing advertising. FIGS. 6 through 8 may illustrate various aspects of monitoring the advertising effect of the advertisements and training of the advertisement system.

FIG. 2 is a flowchart illustrating a method of providing an advertisement according to an embodiment of the disclosure.

In operation S201, the advertisement system 101 may verify the document 104 that is to be displayed on the web page 103. The advertisement system 101 may verify the document 104 when it is registered on the web page 103 by a posting user, or when an advertisement verification field is added and selected on the web page 103 by a posting user. As noted, the web page 103 may be any variety of web page, such as a blog, a cafe, and the like.

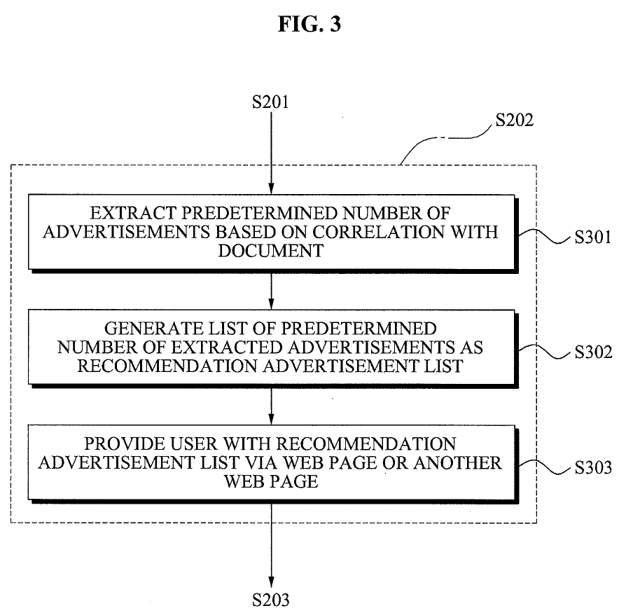

In operation S202, the advertisement system 101 may provide the posting user with the recommendation advertisement list 105 associated with the document 104. The advertisement recommendation list 105 may include a predetermined number of advertisements that are recommended based on a correlation or relevance with the document or its context. That is, the advertisement may be contextual advertising. One example of operation S202 will be described in further detail with reference to FIG. 3.

In operation S203, the advertisement system 101 may identify or determine an advertisement that is selected by the posting user. The selected advertisement may be from the recommendation advertisement list 105, or may be provided from another source, such as the posting user or another server. The advertisement system 101 may verify the selected advertisement via an advertisement selection function included in the recommendation advertisement list. For example, the advertisement system 101 may enable the posting user to select an advertisement by using a corresponding check box in the recommendation advertisement list 105. Other forms of selection and verification are also within embodiments of the present disclosure.

In operation S204, the advertisement system 101 may select another advertisement from the recommendation advertisement list 105. This system advertisement is different from the advertisement selected by the posting user. For example, based on its own algorithm or processes, the advertisement system 101 may determine that its system advertisement may have a better correlation or relevance than the other advertisements in the advertisement recommendation list 105 or the selected advertisement.

In operation S205, the advertisement system 101 may provide the selected advertisement and the system advertisement as advertisement 106 as the web page 103 is requested by various viewing users. The advertisement system 101 may adjust the amount of times that the selected advertisement and the system advertisement are displayed or played on the web page 103 based on a predetermined ratio of traffic.

In operation S206, the advertisement system 101 may measure the advertising effect of the selected advertisement and the system advertisement for an initial, predetermined period of time. The advertising effect may include characteristics, such as a click-through rate (CTR), display time, etc. During this initial predetermined period of time, the advertisement system 101 may provide both the selected advertisement and the system advertisement in various ratios. For example, the advertisement system 101 may provide both advertisements in ratios that are relatively equal or equal. The advertising system 101 may then measure the advertising effect of the selected advertisement and system advertisement based on this equal ratio of display or playback.

In operation S207, the advertisement system 101 may provide the posting user with a predetermined compensation amount based on the advertising effect difference, if any, between the selected advertisement and the system advertisement. For example, when the ratio of CTR of the system advertisement to CTR of the selected advertisement is 3: 1, it is possible to distribute returns of the selected advertisement and the system advertisement based on this difference in advertising effect. Also, it may be possible to provide the posting user with additional profits generated by each advertisement.

In operation S208, the advertisement system 101 may adjust how often it displays the selected advertisement and the system advertisement on the web page 103 based on the advertising effect, after the predetermined period of time. Specifically, after the predetermined period of time, the advertising system 101 may display on the web page 103 only the advertisement with the greater advertising effect, or preferentially display the advertisement that is found to have the greater effect at a higher ratio.

Of course, the present disclosure is not limited to these examples. In some embodiments, it may be possible to analyze a document displayed on the web page 103, provide the posting user with a recommendation advertisement list 105, verify an advertisement that is selected by the posting user is from the recommendation advertisement list 105, and provide the selected advertisement via the web page 103. In other words, it may be possible to assume that the selected advertisement possesses a greater correlation or relevance with the document or its context simply based on the posting user's input. Other variations and modifications may be known to those skilled in the art.

FIG. 3 is a flowchart illustrating a method of providing a recommendation advertisement list according to an embodiment of the disclosure. As shown in FIG. 3, operations S301 through S303 may be included in operation S202 of FIG. 2.

In operation S301, the advertisement system 101 may extract a predetermined number of advertisements based on a correlation or relevance with the document 104 or its context. The correlation or relevance may be a measurement of a mutual relation between the document 104 and the advertisements. For example, the correlation or relevance may be measured based on vocabulary frequency in the document 104 and a keyword associated with the advertisement.

Other various algorithms and modifications may be used to determine whether an advertisement is relevant to the document 104 or its context. For example, the advertisement system 101 may employ known or existing methods of determining contextual advertising, generate the recommendation advertisement list 105, and provide the generated recommendation advertisement list 105 to the posting user at terminal 102.

In operation S302, the advertisement system 101 may generate a predetermined number of extracted advertisements for the recommendation advertisement list 105. The recommendation advertisement list 105 may include information like names representing the advertisement, such as a title, an identifier, and a brand of the extracted advertisement. Other information may also be included in the recommended advertisement list 105.

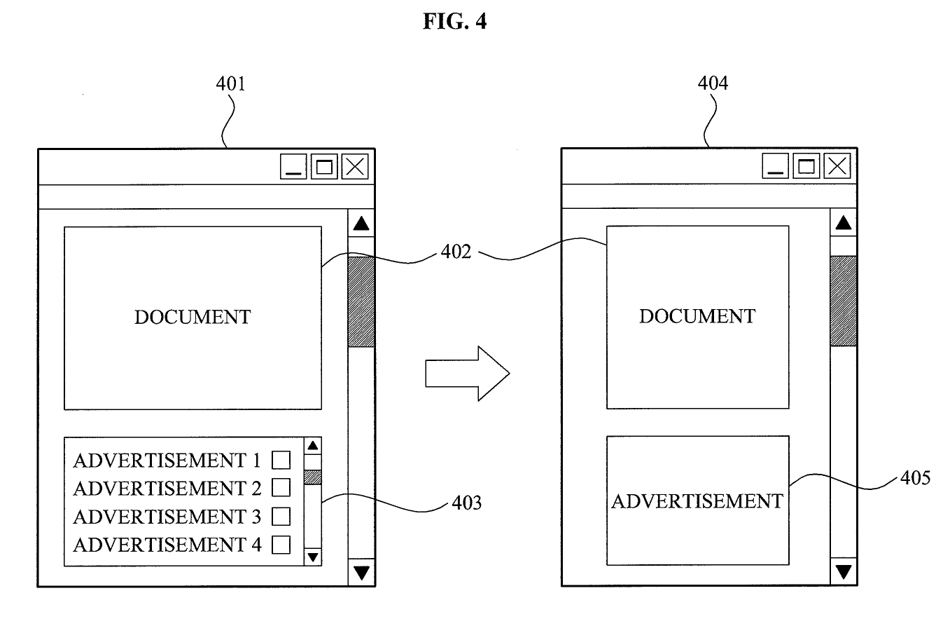

In operation S303, the advertisement system 101 may provide the posting user with the recommendation advertisement list 105 via the web page 103 or another web page. For example, the advertisement system 101 may display the recommendation advertisement list 105 in a region of the web page 103. An example of how this may appear in web page 103 is shown with reference to FIG. 4.

FIG. 4 illustrates an example of providing an advertisement according to an embodiment of the disclosure.

A view 401 is an example of the web page 401 that includes a document 402 registered by a posting user. In this case, the advertisement system 101 may provide the user with a recommendation advertisement list 403 associated with the document 402 via the web page 401. Also, the advertisement system 101 may employ a pop up or another web page to provide the posting user with the recommendation advertisement list 403. 058 For example, when both a selected advertisement and a system advertisement are verified, the advertisement system may 101 provide the selected advertisement and the system advertisement via the web page 401.

Another view 404 shows how either the selected or system advertisement may appear on a web page to a viewing user. As shown, an example of a web page may include an advertisement 405 in association with the document 402. The advertisement system 101 may provide the advertisement 405, including the selected advertisement or the system advertisement, using an advertisement region of the web page 402. As noted, the selected advertisement and the system advertisement may be displayed based on a predetermined ratio of traffic.

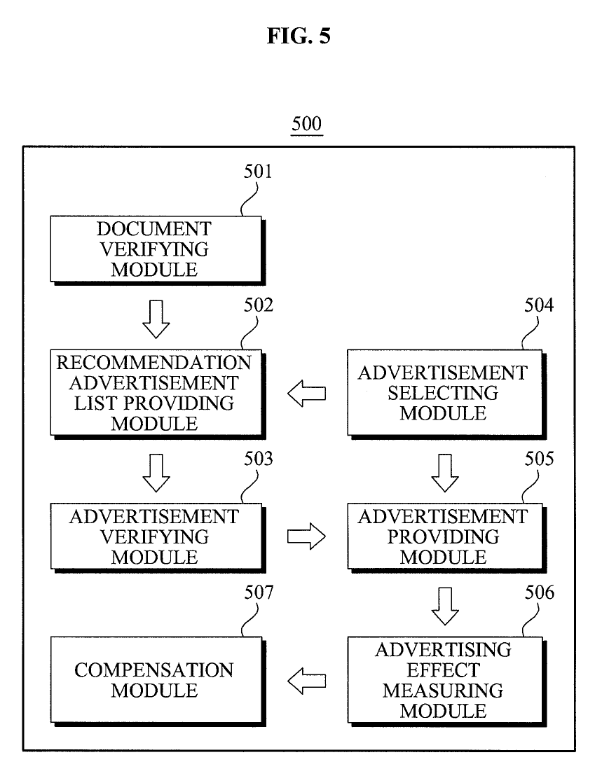

FIG. 5 is a block diagram illustrating an internal configuration of an advertisement system according to an embodiment of the disclosure. As shown in FIG. 5, the advertisement system 500 may include a document verifying module 501, a recommendation advertisement list providing module 502, an advertisement verifying module 503, an advertisement selecting module 504, an advertisement providing module 505, an advertising effect measuring module 506, and a compensation module 507. These modules may be implemented using components of hardware and software. For example, the modules may be implemented in various portions of software or program code that is executed by a processor on a server or other computing device. Alternatively, these modules may be implemented in various combinations of one or more processors or computing devices.

The document verifying module 501 may verify the document 104 to be displayed on the web page 103. In this case, the document verifying module 501 may verify the document 104 when it is registered by the posting user on the web page 103, or when an advertisement verification field is added and selected by the posting user. The web page 103 may be a web page that allows the user to place the document, such as a blog, a cafe, and the like.

The recommendation advertisement list providing module 502 may provide a user with the recommendation advertisement list 105 associated with the document 104. The advertisement recommendation list 105 may include a list of a predetermined number of advertisements that are extracted based on a correlation or relevance with the document 104 or its context.

According to an aspect of the disclosure, the recommendation advertisement list providing module 502 may be configured to extract a predetermined number of advertisements based on a correlation or relevance with the document or its context in order to provide the posting user with the recommendation advertisement list 105. Module 502 may also be configured to generate a predetermined number of extracted advertisements as the recommendation advertisement list 105 and provide the posting user with the recommendation advertisement list 105 via the web page 103 or another web page.

The correlation or relevance may be a measurement of a mutual relation between the document 104 and the advertisement. For example, the correlation or relevance may be measured based on a correlation or relevance between vocabulary frequency in the document 104 and a keyword associated with the advertisement. Various modifications and changes may be employed in extracting advertisements for the document 104.

Module 502 may display the recommendation advertisement list 105 for the posting user in a manner similar to that shown in FIG. 4. FIG. 4 is described further below.

The advertisement verifying module 503 may verify that the selected advertisement is from the recommendation advertisement list 105. The advertisement verifying module 503 may verify the selected advertisement via an advertisement selection function included in the recommendation advertisement list. For example, the advertisement verifying module 503 may enable the posting user to select the advertisement using a corresponding check box.

The advertisement selecting module 504 may select also the system advertisement from the recommendation advertisement list 105, or from some other source. The system advertisement may be different from the selected advertisement. For example, in addition to the selected advertisement, the selecting module 504 may select an advertisement that has the greatest correlation or relevance among advertisements included in the recommendation advertisement list 105 (excluding the selected advertisement).

The advertisement providing module 505 may provide the content of the selected advertisement and the system advertisement to viewing users via a web page. The module 505 may retrieve the advertisement content from the list 105 or from a location indicated in the list 105. Alternatively, module 505 may be provided the content for the advertisements from another server or computing device (not shown). The advertisement display module 505 may adjust the frequency or ratio that the selected advertisement and the system advertisement are displayed on a web page to the viewing user.

The advertising effect measuring module 506 may measure the advertising effect of the selected advertisement and the system advertisement for a predetermined period of time. The advertising effect may include, among other things, a CTR.

The compensation providing module 507 may provide the posting user with a predetermined compensation amount based on the advertising effect difference between the selected advertisement and the system advertisement. For example, when the CTR of the system advertisement versus the CTR of the selected advertisement is 3:1, it may be possible to distribute returns of the selected advertisement and the system advertisement based on this ratio. Also, it may be possible to provide the posting user with additional profits generated by each advertisement. Distributing returns in this manner may be useful to motivate the posting user to attempt to maximize the advertising effect of advertisement that they select.

The advertisement providing module 505 may adjust how often it displays any one of the selected advertisement and the system advertisement on the web page based on the advertising effect, after the predetermined period of time. For example, after the predetermined period of time, module 505 may provide only the advertisement with the greater advertising effect.

FIG. 6 is a flowchart illustrating a method of collecting training data for the advertisement system 101 according to an embodiment of the disclosure.

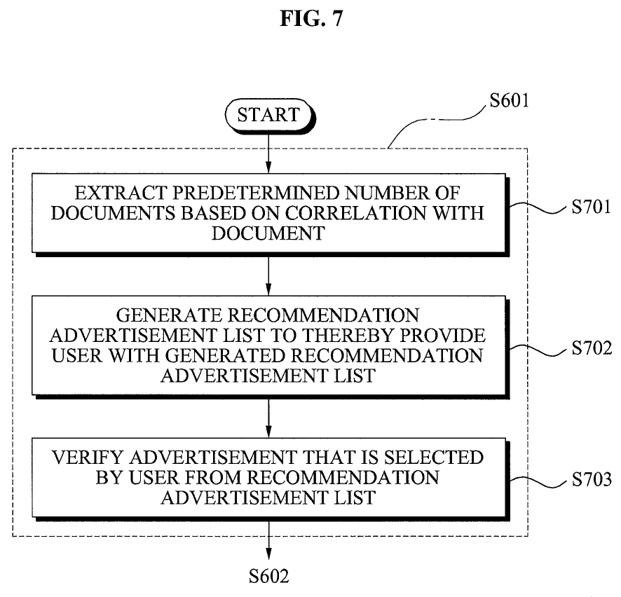

In operation S601, a training data collecting system 800 may verify an advertisement selected by the posting user in association with the document 104. Operation S601 will be further described in detail with reference to FIG. 7.

In operation S602, the training data collecting system 800 may select a system advertisement that is different from the selected advertisement based on a correlation or relevance with the document 104. The training data collecting system 800 may select, as the system advertisement, an advertisement with a greatest correlation or relevance, excluding the selected advertisement from advertisements included in the recommendation advertisement list 105.

In operation S603, the training data collecting system 800 may provide the selected advertisement and the system advertisement via web pages displayed to viewing users and measure the advertising effect of the selected advertisement and the system advertisement. The advertising effect may include, among other things, a CTR. The training data collecting system 800 may display the selected advertisement and the system advertisement on the web page based on the same ratio of traffic so that they are displayed a relatively equal amount to viewing users.

In operation S604, the training data collecting system 800 may compare the advertising effect between the selected advertisement and the system advertisement. The training data collecting system 800 may compare the advertising effect, for example, the CTR, between the selected advertisement and the system advertisement, and thereby select the advertisement with the greater advertising effect as advertisement most appropriate for the document 104.

In operation S605, the training data collecting system 800 may store or archive the advertisement with the greater advertising effect. Data associated with the stored advertisement, the advertising effect, and the document may then be used as training data by the advertisement system 101 when it extracts or retrieves advertisements appropriate for the document 104.

The training data may also be collected by verifying an advertisement selected by a user in association with a document, providing the advertisement via a web page associated with the document, measuring advertising effect of the advertisement, and storing the advertisement based on its advertising effect. Furthermore, the training data may be collected by assuming that the selected advertisement has the greater relevance to the document and storing that advertisement as the one to be associated with the document. 078 FIG. 7 is a flowchart illustrating a method of verifying an advertisement selected by a user and an advertisement selected by the training data collecting system 800 according to an embodiment of the disclosure. As shown in FIG. 7, operations S701 through S703 may be included in operation S601 of FIG. 1.

In operation S701, the training data collecting system 800 may extract a predetermined number of advertisements based on a correlation or relevance with the document 104. The correlation or relevance may be a measurement of a mutual relation between the document 104 and the advertisement. The correlation or relevance may be measured based on a correlation or relevance between vocabulary frequency in the document 104 and a keyword associated with the advertisement.

Other examples and various modifications for correlating and extracting advertisements may be known to those skilled in the art.

In operation S702, the training data collecting system 800 may generate a predetermined number of extracted advertisements as the recommendation advertisement list 105 and provide the posting user with the generated recommendation advertisement list 105 via the web page 103. This list may include names for representing the advertisement, such as a title, an identifier, or a brand of the extracted advertisement. Also, the training data collecting system 800 may display the recommendation advertisement list in a region of the web page 103, or may display the recommendation advertisement list by generating another web page.

In operation S703, the training data collecting system 800 may verify the advertisement selected by the user is from the recommendation advertisement list 105. The training data collecting system 800 may verify the selected advertisement via an advertisement selection function included in the recommendation advertisement list 105. For example, the posting user may select the advertisement using a corresponding check box in the recommendation advertisement list 105.

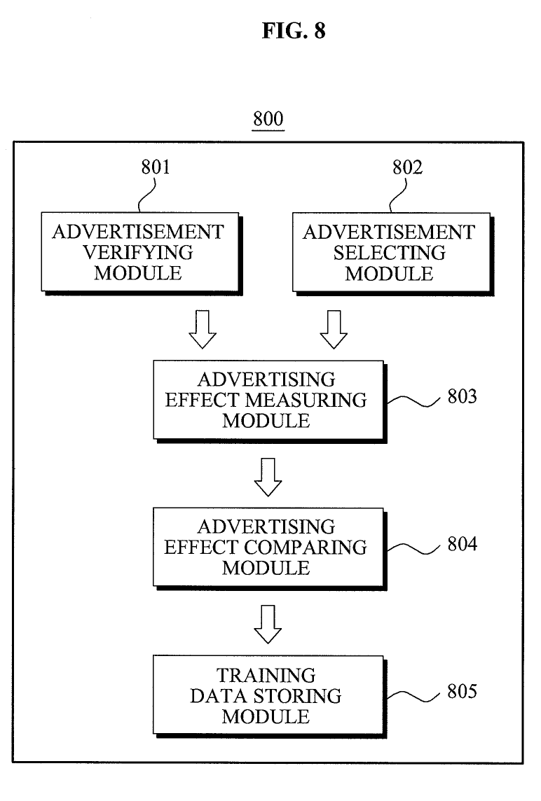

FIG. 8 is a block diagram illustrating an internal configuration of a training data collecting system 800 according to an embodiment of the disclosure. As shown in FIG. 8, the training data collecting system 800 may include an advertising verifying module 801, an advertisement selecting module 802, an advertising effect measuring module 803, an advertising effect comparing module 804, and a training data storing module 805. These modules may be implemented using components of hardware and software. For example, the modules may be implemented in various portions of software or program code that is executed by a processor on a server or other computing device. Alternatively, these modules may be implemented in various combinations of one or more processors or computing devices.

The advertisement verifying module 801 may verify an advertisement selected by a user in association with a document 104 to be displayed on the web page 103. The web page 103 may be a web page that allows the user to place the document 104, such as a blog, a cafe, and the like. For example, the document 104 may be registered by a posting user of the blog or the cafe. For this, the advertising verifying module 801 may be configured to extract a predetermined number of advertisements based on a correlation or relevance with the document. Module 801 may also be configured to generate a predetermined number of extracted advertisements as the recommendation advertisement list 105 and provide the posting user with the generated recommendation advertisement list 105 via the web page 103. Furthermore, module 801 may be configured to verify the advertisement that is selected by the posting user is from the recommendation advertisement list 105.

The advertisement selecting module 802 may select a system advertisement that is different from a selected advertisement based on a correlation or relevance with the document 104 or its context. The advertisement selecting module 802 may determine select the advertisement with the greatest correlation or relevance as the system advertisement from the recommendation advertisement list 105, or from some other source of advertisements.

The advertising effect measuring module 803 may provide the selected advertisement and the system advertisement via the web page 105 and measure the advertising effect of these advertisements. The advertising effect may include, among other things, a CTR. The advertising effect measuring module 803 may display the selected advertisement and the system advertisement on web pages to viewing users at approximately the same ratio of traffic. This allows the advertising effect of the advertisements to be measured under relatively the same conditions.

The advertising effect comparing module 804 may compare the advertising effect between the selected advertisement and the system advertisement. Specifically, the advertising effect comparing module 804 may compare the advertising effect, for example, the CTR, between the selected advertisement and the system advertisement. Module 804 may then determine which advertisement has the greater advertising effect and designate this advertisement as the most appropriate for the document 104.

The training data storing module 805 may store this advertisement in a database (not shown) with the document 104. Alternatively, the advertisement with the greater advertising effect may be stored with an indicator that it was found to be the advertisement most appropriate for the document 104. Data associated with the stored advertisement, the advertising effect, and the document may then be used as training data by the advertisement system 101 to retrieve and extract advertisements.

The exemplary embodiments of the present disclosure include computer-readable media including program instructions to implement various operations embodied by a computer. The media may also include, alone or in combination with the program instructions, data files, data structures, tables, and the like. The media and program instructions may be those specially designed and constructed for the purposes of the present disclosure, or they may be of the kind well known and available to those having skill in the computer software arts. Examples of computer-readable media include magnetic media such as hard disks, floppy disks, and magnetic tape; optical media such as CD ROM disks; magneto-optical media such as optical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present disclosure and vice versa.

According to an embodiment of the disclosure, it is possible to provide an advertisement that is selected by a user from a recommendation advertisement list in association with a document displayed on a web page, via the web page and thereby provide an advertisement that has a greater correlation or relevance with the document.

Also, according to an embodiment of the disclosure, it is possible to display a selected advertisement selected by a user and a system advertisement selected by an advertisement system based on the same ratio of traffic, measure advertising effect, for example, a CTR, of the selected advertisement and the system advertisement, and distribute returns to the user based on the measured advertising effect and thereby motivate the user to improve the service quality and the advertising effect.

In addition, it may be possible to store an advertisement with greater advertising effect between a selected advertisement and a system advertisement in association with a document and use data associated with the stored advertisement and the document as training data for improving how the advertisement system selects or extracts recommended advertisements.

Although a few exemplary embodiments of the present disclosure have been shown and described, the present disclosure is not limited to the described exemplary embodiments. Instead, it would be appreciated by those skilled in the art that changes may be made to these exemplary embodiments without departing from the principles and spirit of the disclosure, the scope of which is defined by the claims and their equivalents.

What is claimed is:

1. A method of advertising, said method comprising:
analyzing a document to be posted on a web page so as to generate a list of advertisements;
providing the generated list of advertisements to a posting user posting the document on the web page;
receiving a selection of the posting user from the generated list;
associating the selection with the document and the web page; and
transmitting a selected advertisement content of the selection to a terminal associated with a viewing user of the web page such that the advertisement content is displayed or played along with the document on the terminal.

2. The method of claim 1, further comprising, along with providing the generated list, providing the posting user with an invitation for selecting at least one advertisement in the generated list.

3. The method of claim 2, wherein the invitation further comprises offering the posting user a value for the selection.

4. The method of claim 1, wherein the selection is associated with the document and web page such that the selected advertisement content of the selection is to be displayed or played when the document is accessed on the web page.

5. The method of claim 1, further comprising:
monitoring an advertising revenue generated from displaying or playing the selected advertisement content on the web page, wherein the value offered to the posting user is to be calculated with reference to the advertising revenue.

6. The method of claim 1, further comprising:
choosing, from the generated list, a non-selected advertisement that is not selected by the posting user; and
transmitting a non-selected advertisement content of the non-selected advertisement such that the non-selected advertisement content is displayed or played along with the document.

7. The method of claim 6, further comprising transmitting the non-selected advertisement content and the selected advertisement content at approximately equal ratios at least for a predetermined period of time.

8. The method of claim 7, further comprising:
determining a desired ratio of transmitting the non-selected advertisement content to transmitting the selected advertisement content based on relative advertising effectiveness of the non-selected advertisement content and the selected advertisement content during the predetermined period; and
subsequent to the predetermined period, transmitting the non-selected advertisement content and the selected advertisement content at the desired ratio.

9. The method of claim 1, further comprising:
monitoring advertisement effectiveness of the selected advertisement content.

10. The method of claim 9, wherein advertisement effectiveness is determined at least based on click through activities of the selected advertisement content.

11. The method of claim 9, further comprising:
monitoring the advertisement effectiveness of a non-selected advertisement; and
providing the posting user with a value calculated based on an advertising revenue generated from the web page and further based on a comparison of the advertisement effectiveness of the selected advertisement versus the advertisement effectiveness of a non-selected advertisement.

12. The method of claim 1, further comprising monitoring click through activities of the selected advertisement content and the non-selected advertisement content.

13. An apparatus comprising means configured to perform the method of claim 1.

14. A computer-readable medium comprising executable program code that configures a device to perform the method of claim 1.

15. A method of posting a document on a web page with at least one advertisement, said method comprising:
submitting, by a posting user, a document for posting on a web page;
receiving, by the posting user, a request for selecting at least one of a list of advertisements for displaying or playing along with the document on the web page;
sending, by the posting user, a selection of the posting user from the list;
viewing, by the posting user, the document on the web page; and
viewing or listening to, by the posting user, a selected advertisement content of the selection displayed or played along with the document on the web page.

16. The method of claim 15, further comprising:
receiving, along with the request for selecting, an offer for compensation in return for selecting at least one of the listed advertisements.

17. The method of claim 15, further comprising:
receiving, by the posting user, compensation calculated with reference to an advertisement revenue generated from the selected advertisement content on the web page.

18. The method of claim 17, wherein the compensation is calculated further based on an advertising effect of the selected advertisement content relative to an advertising effect of a non-selected advertisement content on the web page.

19. The method of claim 15, wherein advertising effect is determined at least based on click-through activities of the selected advertisement content.

20. A method of advertisement at a terminal associated with a user viewing a document on a web page, said method comprising:
receiving a document to be displayed on a web page;
receiving an advertisement content to be displayed or played along with the document on the web page for at least one of an advertisement selected by a posting user that is to be posted with the document on the web page and at least one non-selected advertisement based on advertising effectiveness of the advertisement selected by the posting user and the advertising effectiveness of the at least one non-selected advertisement;
providing the web page on the terminal; and
providing advertisement content for the advertisement to be displayed or played along with the document on the web page.

21. The method of claim 20, further comprising:
monitoring advertising effectiveness of the advertisement content at the terminal.

22. The method of claim 21, wherein monitoring the advertising effectiveness of the advertisement content comprises monitoring click-through activity of the user viewing the web page.

23. The method of claim 21, further comprising providing data that indicates the advertising effectiveness of the advertisement content at the terminal.
